(19) United States
(12) Patent Application Publication
(10) Pub. No.: US 2002/0000970 A1
(43) Pub. Date: Jan. 3, 2002

(54) Image display apparatus

(76) Inventors: Hajime Akimoto, Oume (JP); Yoshiro Mikami, Hitachiota (JP); Toshio Miyazawa, Chiba (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/888,644

(22) Filed: Jun. 26, 2001

(30) Foreign Application Priority Data
Jun. 29, 2000 (JP) 2000-201442

(51) Int. Cl. G09G 3/36

(52) U.S. Cl. 345/100

(57) ABSTRACT

A image display apparatus having a display unit composed of a plurality of pixels and a control unit for controlling the display unit. the image display apparatus further includes a DA converter for converting the digital display data into an analog image signal, wherein the DA converter is composed of a first DA converter and a second DA converter, the Power consumption when the first DA converter is operated being smaller than that when the second DA converter is operated, wherein the DA converter operates either of the first DA converter and the second DA converter according to the instruction from the control unit, and outputs the converted analog image signal to the display unit, and wherein the display unit changes the number of the independent display pixels of said display unit according to the instruction from the control, and displays according to the analog image signal.

### BACKGROUND OF THE INVENTION

The present invention relates to a liquid crystal image display apparatus which can display the image at low power consumption.

Hereafter, the prior art is explained with reference to FIG. 23.

FIG. 23 shows the configuration of the conventional TFT liquid crystal display apparatus.

Display pixel 200 which has liquid crystal capacity 201 and pixel switch 202 is arranged like the matrix. The gate of pixel switch 202 is connected to gate line shift register 204 through gate line 203. Moreover, one end of pixel switch 202 is connected to the DA converters 206A, 206B through signal line 205. The line memory 207A, 207B is connected to the DA converter 206A, 206B, and the display data input line 209A, 209B and the shift register 208A, B are input to the line memory 207A, 207B. Each of the above-mentioned circuit parts is formed on the same substrate by using polysilicon TFT.

Although the pixel drive circuit composed of DA converter 206, line memory 207 and shift register 208 as shown in the Figure has been provided in the top and bottom of the pixel part, for instance, signal line 205 of the odd number row is connected to an upper driving circuit and signal line 205 of the even number row is connected to a lower driving circuit.

Next, the operation of the conventional apparatus is explained.

The digital display data input through the display data input lines 209A, 209B is written in the line memory 207A, 207B one by one by the shift registers 208A, 208B. Next, the display data stored in the line memories 207A, 207B is input to the DA converters 206A, 206B in parallel. The DA converters 206A, 206B output this data on signal line 205 as a voltage of an analog image signal. At this time, when pixel switch 202 of a fixed display pixel line selected by gate line shift register 204 turns on, the voltage of an analog image signal is written in the capacity 201 of the liquid crystal of the selected display pixels. This TFT liquid crystal panel displays the image based on the input display data according to the operation described above. Signal line 205 of the odd number row is connected to an upper driving circuit, and signal line 205 of the even number row is connected to a lower driving circuit as described above. Therefore, the upper and lower driving circuits are synchronously driven, and the display of one screen is allotted to the upper and lower driving circuits.

Here, because the upper and lower circuit plays the role to drive the pixel under the same condition, both has basically the same circuit structures.

For instance, this prior art is described in detail in ISSCC (International Solid-State Circuits Conference) 2000, Digest of technical papers, pp.188-189.

The demand of the installation of a high-definition image display panel which uses the the number of pixels more than that of QCIF (Quarter common intermediate format 144×176 pixels) and CIF (288×352 pixels) for the portable information device along with the practical use of IMT-2000(International Mobile Telecommunications 2000) increases. There is a demand of lightening of the portable information device by lightening the secondary cell in one side. The demand of making image display unit a low power consumption also has strengthened day by day at the same time.

On the other hand, it was essentially difficult to realize making the display image high definition and making it low power consumption at the same time by using the above-mentioned prior art. The reason is that the operation frequency of the liquid crystal panel increases and power consumption increases inevitably if the high definition of display image is performed by the improvement of the number of pixels.

### SUMMARY OF THE INVENTION

An object of the present invention is to provide a image display apparatus with the low power consumption.

Another object of the present invention is to provide a image display apparatus in which the low power consumption and a high-definition image consist with each other.

According to one aspect of the present invention, a image display apparatus has the following configuration. That is, the image display apparatus has a display unit composed of a plurality of pixels and a control unit for controlling the display unit. It further includes a DA converter for converting the digital display data into an analog image signal, wherein said DA converter is composed of a first DA converter and a second DA converter, the Power consumption when said first DA converter is operated being smaller than that when said second DA converter is operated, wherein said DA converter operates either of said first DA converter and said second DA converter according to the instruction from said control unit, and outputs the converted analog image signal to said display unit, and wherein said display unit changes the number of the independent display pixels of said display unit according to the instruction from said control, and displays according to said analog image signal.

According to another aspect of the present invention, a image display apparatus has the following configuration. That is, the image display apparatus has a display unit composed of plural pixels and a control unit for controlling the display unit. the image display apparatus further includes a DA converter for converting digital display data into an analog image signal, wherein said DA converter includes a first DA converter and a second DA converter, and wherein said first DA converter and said second DA converter each convert the input signal into an analog image signal with different number of bit, respectively.

According to a further aspect of the present invention, a image display apparatus has the following configuration. That is, the image display apparatus has a display unit composed of plural pixels, and a control unit for controlling the display unit. The image display apparatus further includes a DA converter for converting digital display data into an analog image signal, wherein said DA converter includes a first DA converter and a second DA converter, and wherein said first DA converter and said second DA converter each convert the input signal into an analog image signal with different frame frequency, respectively.

### BRIEF DESCRIPTION OF THE DRAWINGS

FIG. 1 shows the configuration of the liquid crystal display apparatus according to a first embodiment of the present invention.

FIG. 2 shows the circuit structure of the frame memory in the first embodiment.

FIG. 3 shows the buffer in the first embodiment or the configuration of the latch circuit.

FIG. 4 shows the circuit structure of the SRAM memory cell in the first embodiment.

FIG. 5 shows the memory cell operation timing chart in the first embodiment.

FIG. 6 shows the circuit structure of DA converter base unit in the first embodiment.

FIG. 7 shows the circuit structure from the analog signal line in the first embodiment to the display pixel matrix.

FIG. 8 shows the circuit structure of the gate line shift register in the first embodiment.

FIG. 9 shows the outline of the layout of the display pixel in the first embodiment.

FIG. 10 shows the circuit structure of the line memory in the first embodiment.

FIG. 11 shows the circuit structure of a base unit of the highly accurate DA converter in the first embodiment.

FIG. 12 shows the operation timing chart of the highly accurate DA converter in the first embodiment.

FIG. 13 shows the circuit structure of the frame memory used for “Low power consumption display mode” in a second embodiment.

FIG. 14 shows the circuit structure of the SRAM memory cell in the second embodiment.

FIG. 15 shows the memory cell operation timing chart in the second embodiment.

FIG. 16 shows the outline of the layout of the display pixel in a third embodiment.

FIG. 17 shows the section between the display pixels A-A′ in the third embodiment.

FIG. 18 shows the circuit structure of DA converter base unit in a fourth embodiment.

FIG. 19 shows the configuration of the liquid crystal display apparatus according to a fifth embodiment.

FIG. 20 shows the configuration of the liquid crystal display apparatus according to a sixth embodiment.

FIG. 21 shows the configuration of the liquid crystal display apparatus according to a seventh embodiment.

FIG. 22 shows the configuration of the image display terminal according to an eighth embodiment.

FIG. 23 shows the configuration of the conventional liquid crystal display apparatus FIG. 24 shows the pixel configuration of image display unit according to a ninth embodiment.

### DETAILED DESCRIPTION OF THE PREFERRED EMBODIMENTS

The present invention is explained by using the following embodiments.

(First Embodiment)

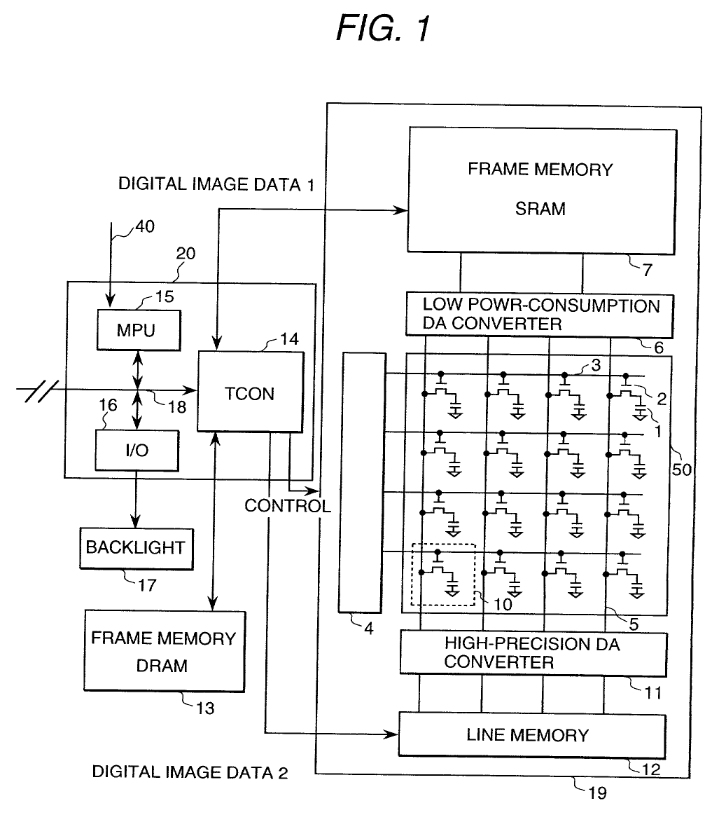

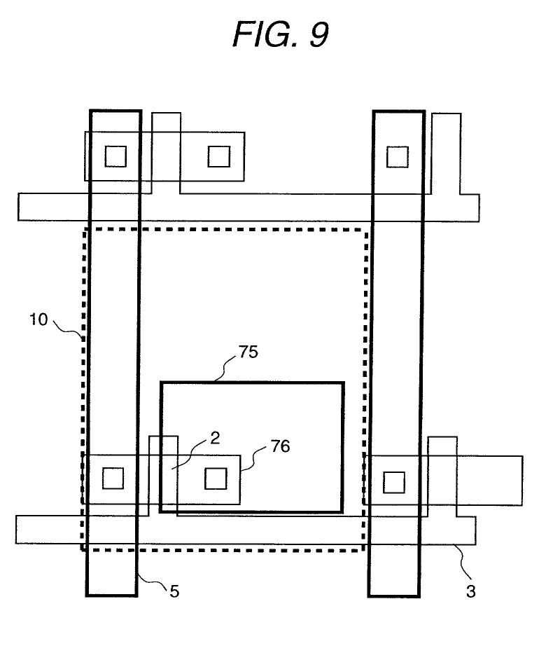

A first embodiment of the present invention is explained with reference to FIG. 1-FIG. 12.

The whole configuration of this embodiment is explained first.

FIG. 1 shows the configuration of the polysilicon TFT liquid crystal display apparatus according to this embodiment.

Display unit 50 is composed of display pixel 10 arranged like the matrix. This display pixel 10 has the liquid crystal capacity 1 and pixel switch 2. The gate of pixel switch 2 is connected to gate line shift register 4 through gate line 3. one end of pixel switch 2 is connected to low power consumption DA converter 6 and highly accurate DA converter 11 through signal line 5. Frame memory 7 composed of SRAM is connected to the input of low power consumption DA converter 6. The frame memory 7 is also connected to timing controller (TCON) 14. Because TCON 14 controls the display unit, it is also called a panel controller. The output of line memory 12 is connected to the input of highly accurate DA converter 11. The input of line memory 12 is connected to TCON 14. TCON 14 is connected to one end of bus 18 and frame memory 13 composed of DRAM. Mainly, main processing unit (MPU) 15, I/O circuit (I/O) 16, etc. are connected to the bus 18. The I/O 16 controls back light unit 17. TCON14, MPU15, and I/O 16 forms control unit 20. Bus 18 may be included in this control unit 20. The components, namely, display pixel 10, gate line shift register 4, low power consumption DA converter 6, frame memory 7, highly accurate DA converter 11, and line memory 12, etc. are formed on a single glass substrate 19 by using polysilicon TFT. A control timing signal from TCON 14 is supplied to those components. On the other hand, TCON 14, frame memory 7, MPU 15, and I/O 16, etc. are composed of single crystal Si-LSI chip. General structures necessary for constructing color TFT panel, namely, a common electrode of the liquid crystal, a color filter, and a back light configuration etc. are omitted from the drawing for the simplification.

Next, the entire operation of this embodiment will be explained. Detailed operation of each part will be described later one by one in the explanation of an individual component.

MPU 15 transmits the digital image display data to frame memory 7 and frame memory 13 through TCON 14. In addition, MPU 15 controls the pixel drive circuit of display unit through TCON 14. This embodiment has two display modes of a low power consumption display mode and a high-definition display mode. When selecting “Low power consumption display mode”, MPU 15 and TCON 14 write data in the panel, and read the image display data from frame memory 7 to MPU 15 by entirely using frame memory 7. The image display data written in frame memory 7 is read one by one, input to low power consumption DA converter 6. The converted signal or analog image signal is written in the capacity 1 of the liquid crystal of pixel selected by gate line shift register 4. The highly accurate DA converter 11, line memory 12, DRAM or frame memory 13, etc. are not driven basically at this “Low power consumption display mode”. Therefore, it is clear that those equipment do not consume the electric power. At this time, the driven circuit is frame memory 7 and low power consumption DA converter 6, etc. which a parallel output and the DA conversion can be performed each pixel line. Accordingly, the liquid crystal display panel can be driven at low power consumption by suppressing the drive frequency to a low level.

Next, when “high-definition display mode” is selected, MPU 15 writes data in the panel, and reads the image display data from frame memory 13 to MPU 15 by entirely using frame memory 13. The image display data written in frame memory 13 is read one by one, and input to highly accurate DA converter 11 through TCON 14 and line memory 12. The converted voltage of an analog image signal is written in the capacity 1 of the liquid crystal of pixel selected by gate line shift register 4. Although low power consumption DA converter 6 is not basically driven at this “high-definition display mode”, the image display data when “Low power consumption display mode” is displayed can be saved in frame memory 7. As for frame memory 7, it is not so suitable to design the panel image frame in a large capacity for the sake of area saving. However, because frame memory 13 is a DRAM-LSI, it is possible to make it to a large capacity comparatively easily. Therefore, the amount of the pixel data (digital image display data 2) in a high-definition display mode becomes remarkably more than the amount of the pixel data (digital image display data 1) in the low power consumption display mode as described later.

Here, MPU 15 controls back light unit 17 through bus 18 and I/O 16. As a rule, a reflection-type liquid crystal display is selected without driving the back light unit at the low power consumption display mode. As a result, power consumption is decreased. However, a more high-quality, transmission-type liquid crystal image is displayed by driving the back light unit and illuminating the display pixel array from the back thereof at a high-definition display mode. Namely, a low power consumption display mode which uses low power consumption DA converter 6 and a high-definition display mode which uses highly accurate DA converter 11 are used properly in this embodiment. It becomes possible to realize both of making the portable information device a super-low power consumption when standing by and displaying an image including the motion image with a high-definition at the same time, by the proper use described above.

These modes can be switched by inputting switch instruction 40 to MPU 15 of control unit 20 for instance. This switching operation is done by the switch instruction given by the instruction of the user.

The component and the operation of each part of this embodiment are sequentially explained next.

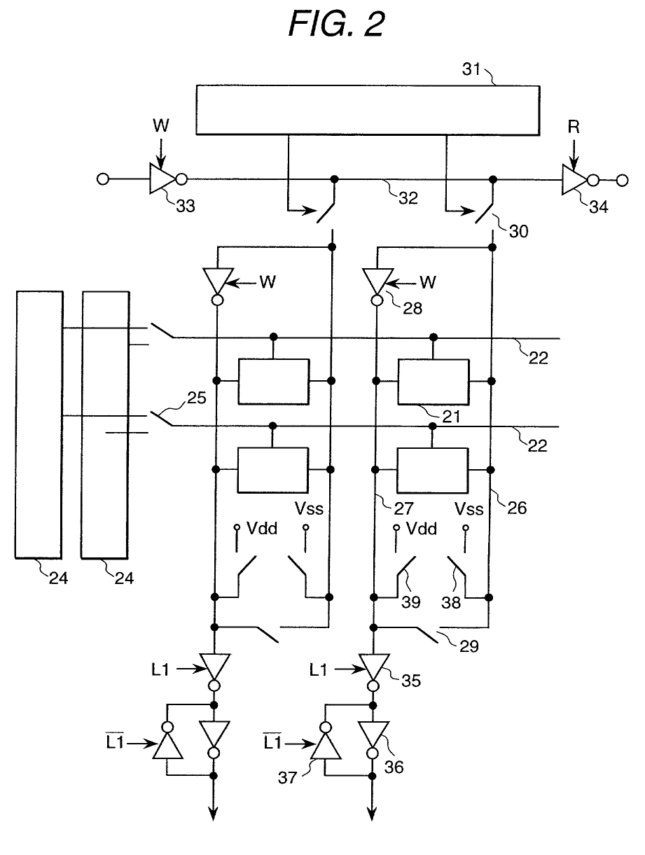

Hereafter, the configuration and operation of frame memory 7 are explained with reference to FIGS. 2 to 5.

FIG. 2 shows the circuit structure of frame memory 7. The word line 22 is connected to SRAM memory cell 21 arranged like the matrix in a line direction. One end of word line 22 is connected to word line shift register 24 or Y decoder 23 through word line selection switch 25. Moreover, memory cell 21 is connected to data line 26 and inverse data line 27 in a column direction. Data line reset switch 38 and inverse data line reset switch 39 are provided in data line 26 and inverse data line 27, respectively. In addition, data line short-circuit switch 29 is provided between them. Inverse data line buffer 28 which operates by the writing signal (W in Figure) is provided in one end of inverse data line 27, and data line 26 is connected to its input. Data input switch 30 is provided in one end of data line 26, and the other end data input switch 30 is connected to data input line 32. Data input switch 30 is selected by X decoder 31. data input buffer 33 which operates by the writing signal (W in Figure) and data output buffer 34 which operates by the reading signal (R in Figure) are connected to both ends of data input line 32. On the other hand, one bit memory composed of data line latch a35 which operates by the latch signal (L1 in Figure), inverter 36, and data line latch b37 which operates by the inverse latch signal (L1 bar in Figure) are arranged on the other the other end of inverse data line 27.

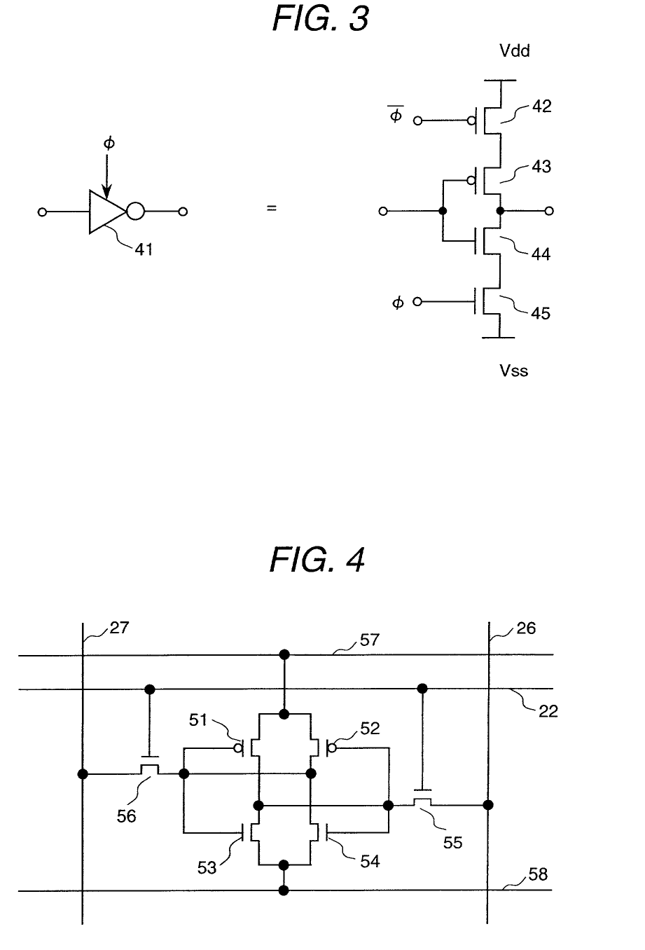

FIG. 3 shows the buffer shown in FIG. 2, that is, the circuit structure of latch circuit 41. The buffer, that is, latch circuit 41 is composed of the CMOS clock and the inverter. P-channel polysilicon TFT 42, 43, and n-channel polysilicon TFT 44, 45 are driven by complementary signal pulse ø. Therefore, three kinds of state-output of Vdd, Vss which are the output of the inverter, or the output-opening are given by selecting the signal pulse.

FIG. 4 shows the circuit structure of SRAM memory cell 21. The main body of the memory cell is a flip-flop composed of p-channel polysilicon TFT 51, 52, and n-channel polysilicon TFT 53, and 54. This circuit is connected to data line 26 and inverse data line 27 through word line switch 55 and inverse word line switch 56 controlled by word line 22. The electric power from high voltage power wire 57 is supplied to the high voltage side of the flip-flop circuit, and the electric power from low voltage power wire 58 is supplied to the low voltage side.

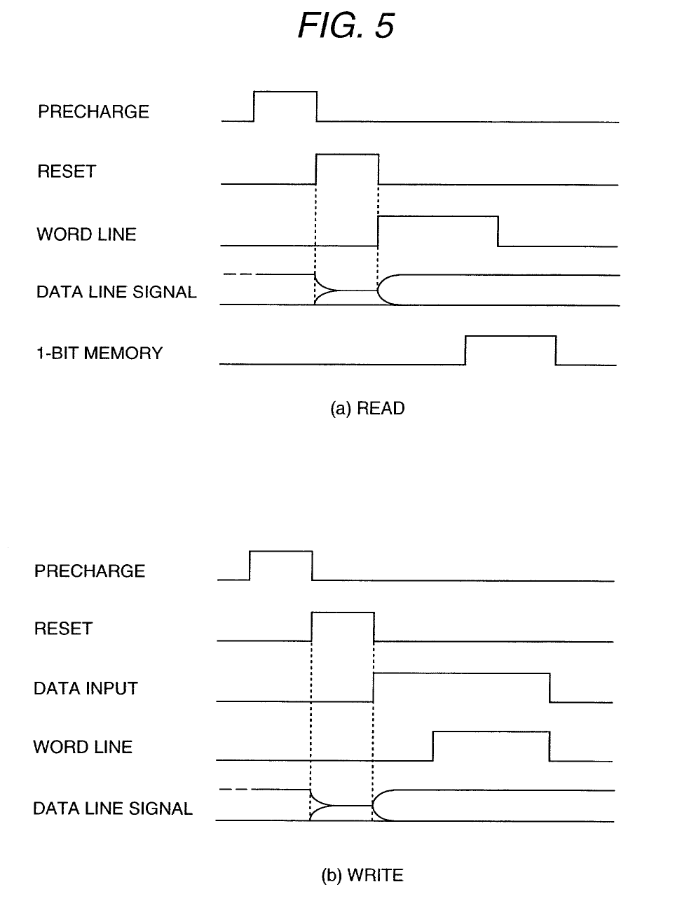

Next, the operation of frame memory 7 is explained with reference to FIG. 5. FIG. 5(a) and (b) are the timing charts showing the writing operation of data to the memory cell and the reading operation from the memory cell, respectively. Here, the upper part of the Figure shows the high voltage output, that is, on-state, and the lower part of the Figure shows the low voltage output, that is, off-state.

First of all, in the reading operation, data line reset switch 38 and inverse data line reset switch 39 precharges data line 26 and inverse data line 27 at low voltage level and high voltage level, respectively. Then, data line 26 and inverse data line 27 are reset to the middle value between the low voltage level and the high voltage level as shown in Figure. Next, when word line 22 selected by word line shift register 24 is turned on, the data stored in selected memory cell 21 is read to data line 26 and inverse data line 27 as signal voltages which conflict to each other. Then, the data stored in memory cell 21 can be read to one bit memory composed of data line latch a35, inverter 36, and data line latch b37 by turning on or turning off data line latch a35 and data line latch b36.

Next, the case where the content of the memory cell is read to bus 18 through TCON 14 will be explained. At this time, it is similar to the case where data is read to one bit memory, excluding that word line 22 selected by Y decoder 23 is turned on, and that the data of the address selected by X decoder 31, among the data read to data line 26, is output through data input switch 30, data input line 32, and data output buffer 34.

Next, in the writing operation, data line reset switch 38 and inverse data line reset switch 39 precharges data line 26 and inverse data line 27 at the low voltage level and the high voltage level, respectively. In the subsequent reset, data line short-circuit switch 29 makes short-circuit of data line 26 and inverse data line 27, and both is reset to the middle value between low voltage level and the high voltage level, respectively. These operation is similar to the reading operation. Next, when data input switch 30 selected by X decoder 31 is turned on, the input data input from data input buffer 33 to data input line 32 is input to data line 26 and inverse data line 27. Under such a condition, when word line 22 selected by Y decoder 23 is turned on, the input data input to data line 26 and inverse data line 27 is written in memory cell 21 selected by X decoder 31. At this time, it is clear that the data of memory cell 21 not selected by X decoder 31 does not change by the above-mentioned writing operation.

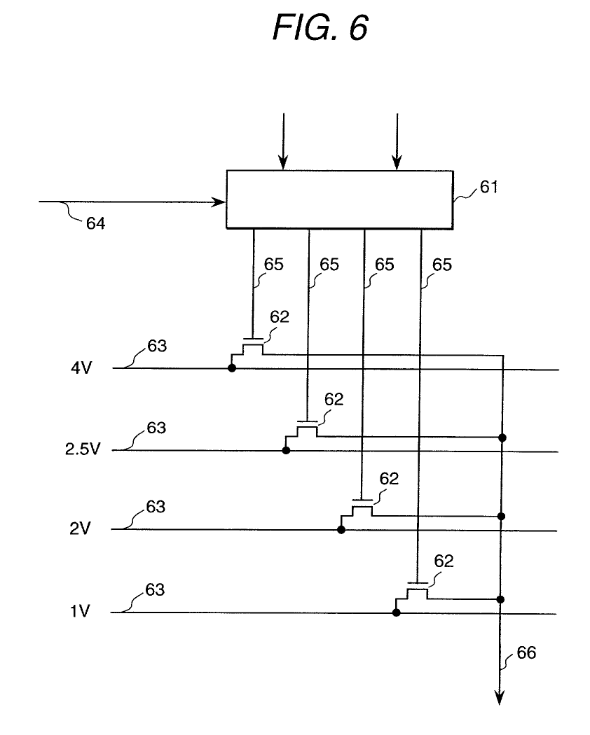

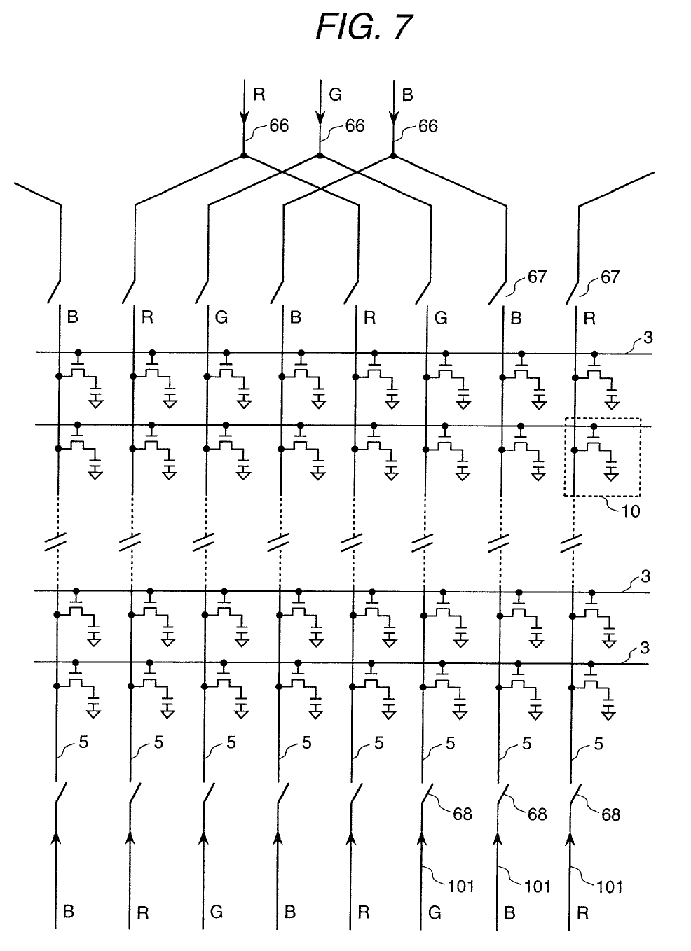

Next, the configuration and the operation of low power consumption DA converter 6 are explained with reference to FIGS. 6 and 7.

FIG. 6 shows the structure of the base unit of the circuit which corresponds to one column of low power consumption DA converter 6. The data output from the frame memory 7 is input to data decoder 61 every two bits. four output lines 65 is extended from data decoder 61. Analog voltage selection switch 62 is provided in each output line 65, and one end of analog voltage selection switch 62 is connected to reference voltage line 63. The other end of analog voltage selection switch 62 joins one and forms analog signal line 66. Field inverse signal line 64 is separately input to data decoder 61.

FIG. 7 shows the configuration between the above-mentioned analog signal line 66 and the display pixel matrix. Although the stripe filter of RGB or 3 color is provided to the pixel matrix to display in colors, The colors of the filter are shown as R, G, and B. Analog signal line 66 is branched to two lines, which are connected to the adjacent signal line 5 which has the same color color filter through low power consumption DA output switch 67.

Next, the operation of low power consumption DA converter 6 is explained. The data output from the frame memory 7 shows the image data of one unit or two bits. On the other hand, data decoder 61 performs the decode-processing to four values from two bits, and turns on either of four analog voltage selection switches 62 through output line 65. As a result, the voltage of reference voltage line 63 selected is applied to analog signal line 66. In this embodiment, to decrease the number of reference voltage line 63, the common electrode of the liquid crystal is driven by alternating current 0/5V between fields. At this time, the output of data decoder 61 should be reversed, for instance, with 4V/1V between the field even the same black. Data decoder 61 uses field inverse signal line 64 to obtain the polarity information on a liquid crystal common electrode when decoding.

Well, only half of the number of column of the display pixel is provided as for the number of analog signal line 66. Then, analog signal line 66 is branched to two lines on the way. The voltage of reference voltage line 63 previously selected is equally input to two adjacent signal lines 5 which have the same color filter through low power consumption DA output switch 67 turned on only at the low power consumption display mode. The reduction in the occupation area in frame memory 7 arranged in the image frame of the liquid crystal display panel and the decrease of power consumption are achieved in this embodiment by making the number of pixel data in the column direction stored in frame memory 7 halves of the number of column of the display pixel.

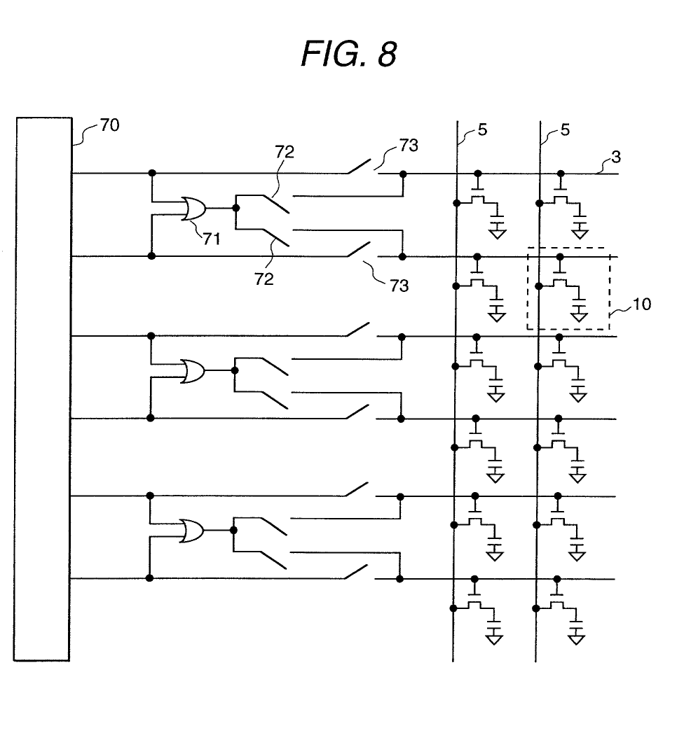

Next, the configuration and the operation of gate line shift register 4 are explained with reference to FIG. 8.

FIG. 8 shows the circuit structure of gate line shift register 4. The outputs of shift register circuit 70 for scanning the gate line one by one are input to OR circuit 71 every two outputs, and the output of OR circuit 71 is branched and connected to gate line 3 through pair scanning switch 72. Moreover, sequential scanning switch 73 which connects the output of shift register circuit 70 directly to gate line 3 is provided besides them.

Shift register circuit 70 selects the output one by one. However, the gate lines adjacent in the top and bottom are scanned simultaneously every two lines, because pair scanning switch 72 is in an on-state and sequential scanning switch 73 is in an off-state, in the low power consumption display mode. In this embodiment, the number of pixel data in a line direction stored in frame memory 7 is made the half of the number of lines of the display pixel by writing the same analog signal voltage to the adjoining display pixel of two lines. As a result, the reduction in the occupation area and the decrease of the power consumption in frame memory 7 are realized.

Next, the configuration and the operation of display pixel 10 are explained with reference to FIG. 8.

FIG. 8 is a layout schematic diagram of display pixel 10. Signal line 5 is provided in a column direction, and gate line 3 is provided in a line direction. Pixel switch 2 using polysilicon thin film 76 is provided in the neighborhood of the intersection of the signal line and the gate line. Moreover, the electrode for the formation of the capacity of the liquid crystal composed of metal electrode 75 and the transparent electrode (not shown for the simplification) is formed in one end of pixel switch 2. The configuration shown in the square is an electric contact here.

When gate line 3 is selected, the voltage applied to signal line 5 is written in the capacity 1 of the liquid crystal, and an optical characteristic of the liquid crystal is modulated, and the image is displayed. When back light 17 is lit, the light from the back light is penetrated the liquid crystal layer through the part where metal electrode 75 is missing. The image is displayed in this case as a transmission-type liquid crystal display panel. On the other hand, the incident light from the upper side of the screen can be reflected by metal electrode 75 when back light 17 is not lit either, and the liquid crystal layer is penetrated the reflected light in a similar way. Therefore, the image is displayed also as a reflection-type liquid crystal display panel in this embodiment. Although back light 17 is required not to be lit basically when the low power consumption display mode is selected, the reflection-type image display can be performed at the same time by adopting the configuration of such display pixel 10. in this embodiment.

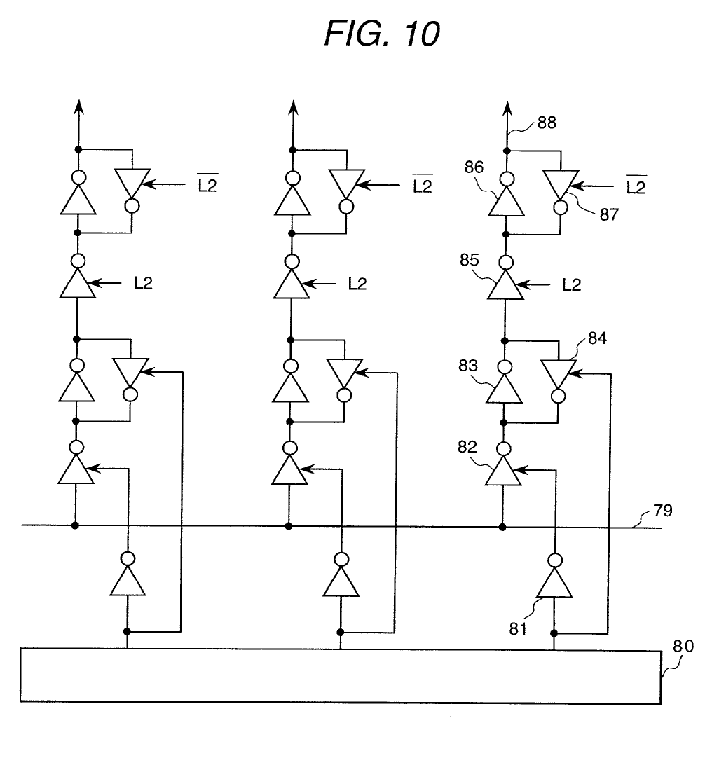

Next, the configuration and the operation of line memory 12 are explained with reference to FIG. 10.

FIG. 10 shows the circuit structure corresponding to three columns of line memory 12. Data input line 79 output from the frame memory 13 is input to the first latch circuit composed of data line latch c82, inverter 83, and data line latch d84. The output of the first latch circuit is connected to data line 88 through the second latch circuit composed of data line latch e85 which operates by the latch signal (L2 in Figure), inverter 86, and data line latch f87 which operates by the inverse latch signal (L2 bar in Figure). The first latch circuit is controlled by shift register circuit 80 and inverter 81 connected thereto.

The digital display data is input from fram memory 13 through TCON 14 to data input line 79 one by one. In synchronization with this, shift register circuit 80 samples the input digital element data and output them to a first latch circuit composed of data line latch c82, inverter 83, and data line latch d84. The second latch circuit composed of data line latch e85, inverter 86, and data line latch f87 is driven when data input for one line is completed, and the data corresponding to one line stored in the group of the first latch circuits is memorized. Then the first latch circuit begins to sample the following digital display data. The second latch circuit keeps outputting the digital display data latched to data line 88 during this period of time. To simplify the drawing, only the circuit which corresponds to one bit is shown in the Figure, though the digital display data output from the frame memory 13 is composed of 6 bits in this embodiment.

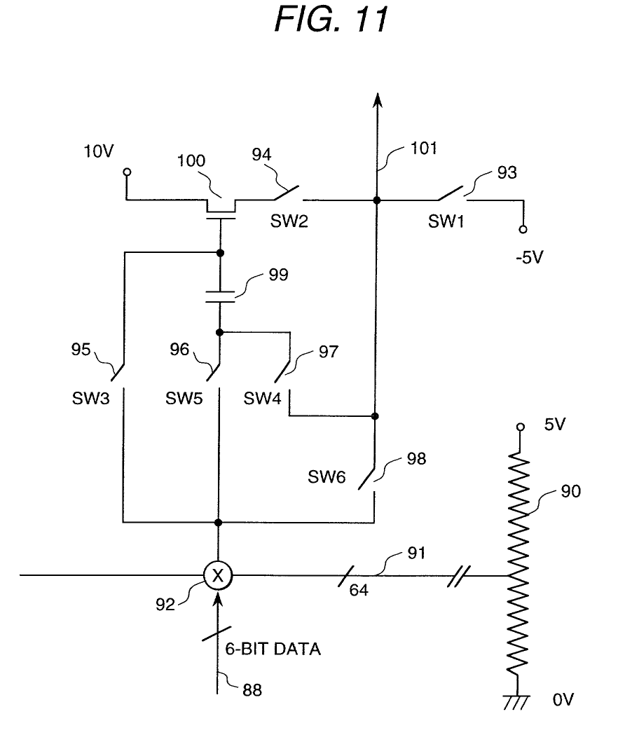

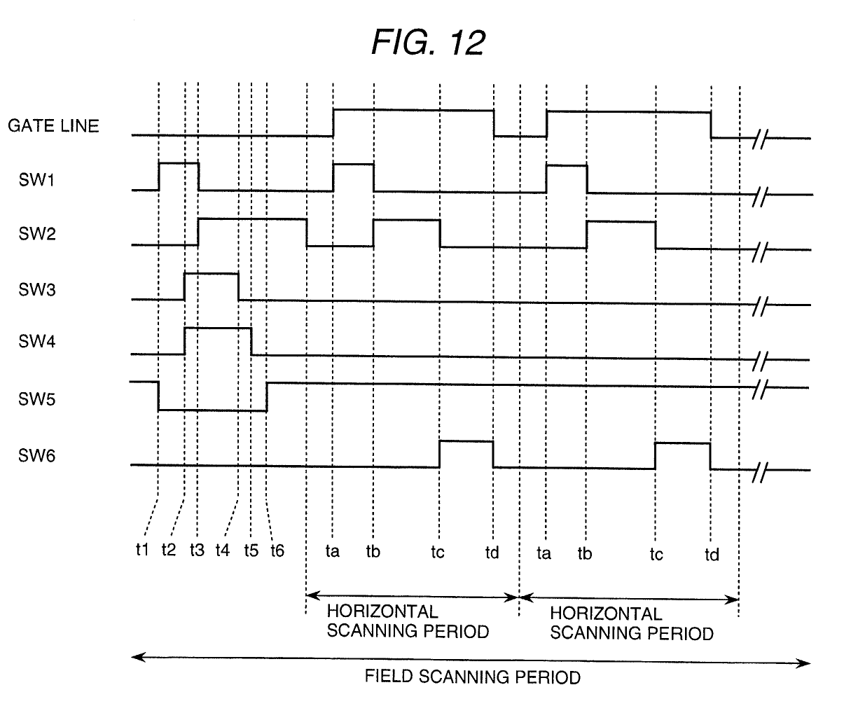

Next, the configuration and the operation of highly accurate DA converter 11 are explained with reference to FIG. 11, FIG. 12, and FIG. 7.

FIG. 11 shows the circuit structure of one unit of highly accurate DA converter 11.

Data line 88 output from the second above-mentioned latch circuit is settled to 6 bits and then input to multiplexer 92. Besides, 64 reference voltage lines 91 extended from the ladder resistance 90 are input to multiplexer 92.

Multiplexer 92 selects one provided beforehand from 64 reference voltage lines 91 based on digital data of six bits, and connects this to SW3 95, SW5 96, and SW6 98. The voltages 0V and 5V are applied at both ends of the ladder resistance, and each middle voltages are input to 64 reference voltage lines 91. The other end of SW3 95 is connected to the gate of precharge TFT 100 and one end of threshold cancellation capacity 99. The other end of SW5 96 is connected to the other end of the threshold cancellation capacity 99 and one end of SW4 97. Moreover, the other end of SW6 98 is connected to the other end of SW4 97 and signal line 101. Moreover, signal line 101 is connected to −5V through SW1 93, and connected to the source of precharge TFT 100 through SW2 94. High voltage 10V is applied to drain of precharge TFT 100 composed of the polysilicon.

Next, the operation of highly accurate DA converter 11 is explained with reference to FIG. 12 in which the operation timing chart of highly accurate DA converter 11 is shown.

First of all, the threshold voltage of precharge TFT 100 is written in the threshold cancellation capacity 99 at the beginning of one field. The output of multiplexer 92 is fixed to 5V power supply voltage during this period. SW1 is turned on at the period t1-t2, and the voltage of signal line 101 is reset ot −5V. Next, SW3 and SW4 are turned on at the period t2-t3, and both ends of the threshold cancellation capacity 99 are connected. Then, SW1 is turned off at the period t3-t4, and SW2 is turned on. As a result, precharge TFT 100 operates as a source follower, and the voltage of signal line 101 is charged to (5V-Vth). When SW3 was turned off at the period t4-t5 after the charge had been completed, the voltage which corresponds to the threshold Vth of precharge TFT 100 was written in the threshold cancellation capacity 99. Next, after SW4 is turned off, SW5 is turned on at the period t5-t6. As a result, the voltage higher by Vth than the output of multiplexer is input to the gate of the precharge TFT 100.

The horizontal scanning period continuously is begun after the writing of the above-mentioned threshold voltage is completed. The digital display data corresponding to one line stored in line memory 19, is digital-to-analog converted and output from multiplexer 92, and then is written in the display pixel one by one in each horizontal scanning period. First of all, gate line 3 selected by gate line shift register 4 is turned on and SW1 is turned on at the period ta-tb, and the voltage of signal line 101 is reset to −5V. Continuously, SW2 is turned on, and precharge TFT 100 is made to operate as a source follower at the period tb-tc. As a result, signal line 101 is precharged to the analog signal voltage output from multiplexer 92. When SW6 is turned on instead of SW2 at period tc-td after this precharge is completed, multiplexer 92 write the analog signal voltage directly in signal line 101. However, because the signal line 100 is substantially already precharged to this analog signal voltage at this time, and the data written in signal line 101 at the period tc-td is only a fluctuation correction of the voltage occurred at precharge. Therefore, the electric current output from multiplexer 92 is an extremely small in this embodiment. It is possible to design the value of resistor to comparatively large value because a substantially direct current to ladder resistor 90 for supplying the electric current to reference voltage line 91 does not flow. As a result, the power consumption which originates in the penetration electric current of the ladder resistance can be extremely adjusted to the small value in this embodiment. Vth of precharge TFT 100 is canceled by using the threshold cancellation capacity 99 in this embodiment as described above. The purpose is to evade charging current corresponding to Vth flowing to signal line 101 when SW6 is turned on, and the analog signal voltage is written directly from multiplexer 92 in signal line 101. It becomes possible to set ladder resistance 90 for supplying an electric current to reference voltage line 91 to the resistor with larger resistance. As a result, the power consumption in the liquid crystal display panel can be decreased.

Well, the top of signal line 101 shown in FIG. 11 is connected to the bottom of FIG. 7, that is, connected to signal line S through highly accurate DA output switch 68. This highly accurate DA output switch 68 and low power consumption DA output switch 67 are turned on or turned off according to a high-definition display mode and the low power consumption display mode, respectively, by selecting and either highly accurate DA converter 11 or low power consumption DA converter 6.

The number of signal line 101 and the number of display pixel frames are equal to each other while the number of analog signal line 66 is only half the number of the column of display pixel as previously described. The reason is as follows. That is, although the power consumption and the occupation area of frame memory 7 is reduced by supplying the same signal data voltage to two adjacent signal lines 5 which have the same color filter in the low power consumption display mode as mentioned above, it is required to supply a different signal data voltage to individual signal line 5 in a high-definition display mode in order to realize the minuteness degree twice “low power consumption display mode” in columnwise direction.

In addition, shift register circuit 70 scans directly gate line 3 by using sequential scanning switch 73 in the high-definition display mode as described previously by using FIG. 8 in connection with gate line shift register 4. As a result, the minuteness degree twice “low power consumption display mode” can be achieved also in a line direction by setting the horizontal scanning period of high-definition display mode (one line period) to be half the low power consumption display mode.

As a result, the quadruple resolution can be achieved in the high-definition display mode, comparing with the low power consumption mode. The number of pixels in the high-definition display mode corresponds to QCIF (144×176 pixels) format and the the number of pixels in the low power consumption display mode conforms to CIF (288×352 pixels) format in this embodiment. Further, as described previously, RGB of the image data in the low power consumption display mode is of two bits, and RGB of the image data in the high-definition display mode is of six bits. For this reason, the memory capacity of frame memory 13 composed of DRAM-LSI is designed 12 times as greatly as the memory capacity of frame memory 7 composed of SRAM by using polysilicon TFT on glass substrate 19.

In this embodiment, display pixel 10, gate line shift register 4, low power consumption DA converter 6, frame memory 7, highly accurate DA converter 11, and line memory 12, etc. are formed by using the polysilicon TFT elements on glass substrate 19. It may be possible to use transparent insulating materials such as quartz substrates and plastic substrates instead of the glass substrate.

It is appreciated that the configuration in which conductive type and the voltage relation between n-type and p-type TFT is made in opposite way, and other circuit structures can be used within the range of the spirit of the present invention.

The image data in a low power consumption display mode in this embodiment is composed of 2 bits and the number of pixel data 144×176 pixels, the image data in a high-definition display mode is composed of 6 bits and the number of pixel data were assumed to be 288×352 pixels. However, It is needless to say to be able to change these values within the range of the spirit of the present invention.

In addition, it is possible to select a driving method in which the number of the frame per one second (frame rate) when low power consumption display mode is selected is fewer than that in a high-definition display mode. Because the reflection-type liquid crystal display mode is applied and thus the contrast of display image is comparatively low when low power consumption display mode is selected, it is very difficult to see flicker even if the frame rate is decreased. Even if the frame rate in the high-definition display mode is assumed to be 60 Hz for instance, the frame rate in the low power consumption display mode can be decreased to about 15 Hz. As a result, a basic drive frequency when the low power consumption display mode is selected is decreased, and it becomes possible to achieve lower power consumption.

The scanning function of gate line shift register 4 in the low power consumption display mode and the high-definition display mode was assumed to be switchable to the function for scanning the adjacent gate line in the upper and lower direction every two line at the same time and the function for scanning individually each gate line by switching pair scanning switch 72 and sequential scanning switch 73. Needless to say, the circuit structure which has a similar function can be adopted in gate line shift register 4. For instance, when the gate lines adjacent in the upper and lower direction are scanned at the same time three or more, individual shift register circuit 70 can be provided in the low power consumption display mode. Futher, shift register circuit 70 can be provided individually for the low power consumption display mode and for a high-definition display mode. In addition, the shift register circuit 70 provided individually can be arranged on the right and left sides of the display pixel matrix without deviating the range of the spirit of the present invention.

Although the CMOS switch, pixel TFT 12 or n-type TFT switch is adopted for various switch group in this embodiment, it is possible to use other switch configuration such as a p-type TFT, etc. Moreover, it is also appreciated that various layout are applicable within the range of the spirit of the present invention.

To sum up the present invention, the image display apparatus has a display unit 50 composed of plural pixels 10 and a control unit 20 for controlling the display unit 50. In addition, this image display apparatus has DA converter (low power consumption DA converter 6 and highly accurate DA converter 11) for converting the digital display data into an analog image signal. The DA converter is composed of the first DA converter (low power consumption DA converter) and the second DA converter (highly accurate DA converter 11). When these two DA converter is compared in the point of power consumption during operation, the power consumption when the first DA converter is operated becomes smaller than the power consumption when said second DA converter is operated. Either the first DA converter or the second DA converter is operated according to an instruction control unit 20, and the converted analog image signal is output to display unit 50. The number of display pixels (independent display pixel) corresponding to mutually different digital display data is changed according to an instruction from control unit 20, and the display according to an analog image signal is peformed to display unit 50.

It becomes possible to provide a image display apparatus which can realize the high-definition display and the low power consumption at the same time by separating the image to be displayed with high definition from the image not to be required to display with high definition as described above.

In a broad sense, the image display apparatus which can display the image at the low power consumption can be provided.

Furthermore, gate line shift register 4 which controls the scanning of display unit 50 is connected to display unit 50, and control unit 20 outputs an instruction to gate line shift register 4. Then, the number of independent display pixels of display unit 50 is changed by gate line shift register 4. This control unit 50 gives the instruction to DA converter (6 or 11) and gate line shift register 4 according to mode switch instruction 40.

The mode switch instruction for switching the mode has two modes of a first mode for performing the conversion processing by the first DA converter and a second mode for performing conversion processing by the second DA converter. The pixels 10 of the display unit 50 correspond to the region enclosed by plural gate lines 3 and plural signal lines 4 arranged to intersect the plural gate lines 3. Gate line shift register 4 controls at least two gate lines of plural gate lines at the same timing according to the instruction in the first mode, and the first DA converter can output one converted analog image signal to at least two signal lines.

Furthermore, two memories (frame memories 7 and 13) with different capacity which corresponds to the first DA converter and the second DA converter respectively are arranged in the image display apparatus.

Moreover, it is appreciated that other configuration can be used in which display unit 50, memory 7 with smaller capacity of two memories, DA converter (6, 11), and gate line shift register 4 may be formed on the same substrate, and memory with smaller capacity may be formed with the polysilicon.

It is appreciated that the configuration in which the memory with smaller capacity corresponds to the first DA converter, and the memory with larger capacity corresponds to the second DA converter, may be used.

The first DA converter 6 and the second DA converter 7 each convert the input signal into an analog image signal with different number of bit, respectively.

The first DA converter 6 and the second DA converter 7 each convert the input signal into an analog image signal with different maximum drive frequencyt, respectively.

The first DA converter 6 outputs an analog image signal with binary gradation.

The image display apparatus further has an illumination means (for example, a back light 17) for supplying light to the display unit, and the illumination means supplies light to the display unit 50 in said second mode.

To sum up the present invention from another viewpoint, The image display apparatus includes a display unit 50 composed of plural pixels, and a control unit 20 for controlling the display unit. The image display apparatus further includes a DA converter for converting digital display data into an analog image signal. The DA converter includes a first DA converter (low power consumption DA converter 6) and a second DA converter (highly accuracy DA converter 11), and the first DA converter and the second DA converter each convert the input signal into an analog image signal with different number of bit, respectively.

Either one of the first DA converter and the second DA converter converts digital data into an analog image signal in accordance with an instruction from the controller 20.

The control unit 20 gives an instruction to either one of said first DA converter and said second DA converter in accordance with the mode switch instruction.

Two memories (frame memory 7 and 13) with different capacity are provided so as to correspond to the first DA converter and the second DA converter of the image display apparatus respectively.

Display unit 50, DA converter (6, 11), and gate line shift register 4 is arranged on the same substrate, and display unit 50 is rectangular, and the first DA converter and the second DA converter is arranged in the top and bottom of display unit.

The memory with small capacity of the above-mentioned two memories is arranged on the substrate, and the memory with small capacity can be formed with the polysilicon.

Mode switch instruction 40 has the first mode in which the conversion processing is performed by the first DA converter, and the second mode in which the conversion processing is performed by the second DA converter. The memory with small capacity corresponds to the first DA converter, and the memory with large capacity corresponds to the second DA converter.

The display unit 50 changes the number of the independent display pixels of the display unit according to the instruction from the control unit 20, and displays according to the analog image signal.

The first DA converter outputs an analog image signal with binary gradation.

The image display apparatus has an illumination means (back light 17) for supplying light to the display unit 50. The illumination means supplies light to the display unit 50 in the second mode.

To sum up the present invention from another viewpoint, the image display apparatus has a display unit 50 composed of plural pixels, and a control unit 20 for controlling the display unit. The image display apparatus further has DA converters (low power consumption DA converter 6 and highly accuracy DA converter 11) for converting digital display data into an analog image signal. The DA converters includes a first DA converter (low power consumption DA converter 6) and a second DA converter (highly accuracy DA converter 11). The first DA converter and the second DA converter each convert the input signal into an analog image signal with different frame frequency, respectively.

Either one of the first DA converter and the second DA converter converts digital data into an analog image signal in accordance with an instruction from the controller 20. The control unit 20 gives an instruction to either one of said first DA converter and said second DA converter in accordance with the mode switch instruction.

The first DA converter outputs an analog image signal with binary gradation.

The image display apparatus according to the present invention further includes an illumination means (back light 17) for supplying light to the display unit 50. The illumination means supplies light to the display unit 50 in the second mode.

(Second embodiment)

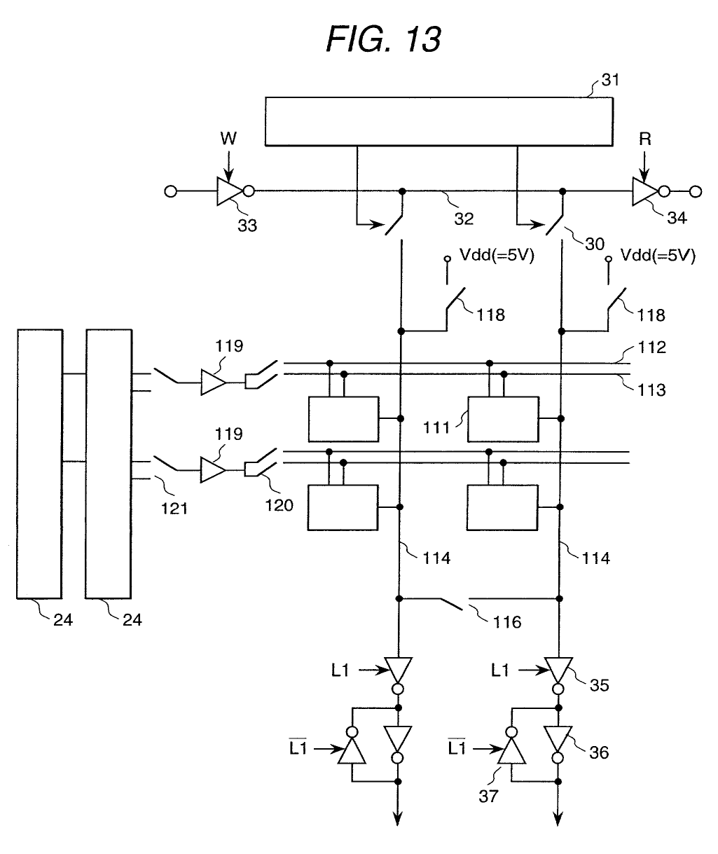

Hereafter, the second embodiment in the present invention will be explained with reference to FIGS. 13-15.

Because the main configuration and the operation of the polysilicon TFT liquid crystal display panel according to the second embodiment are similar to that of the first embodiment, the explanation is omitted. The difference between the first embodiment and this embodiment is the configuration and the operation of the frame memory used in the low power consumption display mode. this is described hereinafter.

FIG. 13 shows the configuration of frame memory 7 used in the low power consumption display mode of this embodiment. FIG. 3 corresponds to FIG. 2 illustrating the first embodiment. Word line 112 and latch line 113 are connected in a line direction to SRAM memory cell 111 arranged like the matrix. One end of word line 112 and latch line 113 is connected to word line shift register 24 or Y decoder 23, through line drive switch 120, buffer 119, and line selection switch 121. Moreover, memory cell 111 is connected to data line 114 in a column direction. Data line 114 has two lines, and data line Vdd reset switch 118 or data line Vss reset switch 117 has been provided in respective lines. In addition, data line short-circuit switch 116 is provided between the two lines. Here, Vdd is set to 5V, and Vss is set to 0V. Data input switch 30 has been provided in one end of data line 114. The other end of data input switch 30 is connected to data input line 32. Moreover, data input switch 30 is composed so as to be selected by X decoder 31. Data input buffer 33 which operates by the writing signal (W in Figure) and data output buffer 34 which operates by the reading signal (R in Figure) are connected to both ends of data input line 32, respectively. On the other hand, one bit memory composed of data line latch a35 which operates by the latch signal (L1 in Figure), inverter 36, and data line latch b37 which operates by the inverse latch signal (L1 bar in Figure) is arranged on the other end of data line 114.

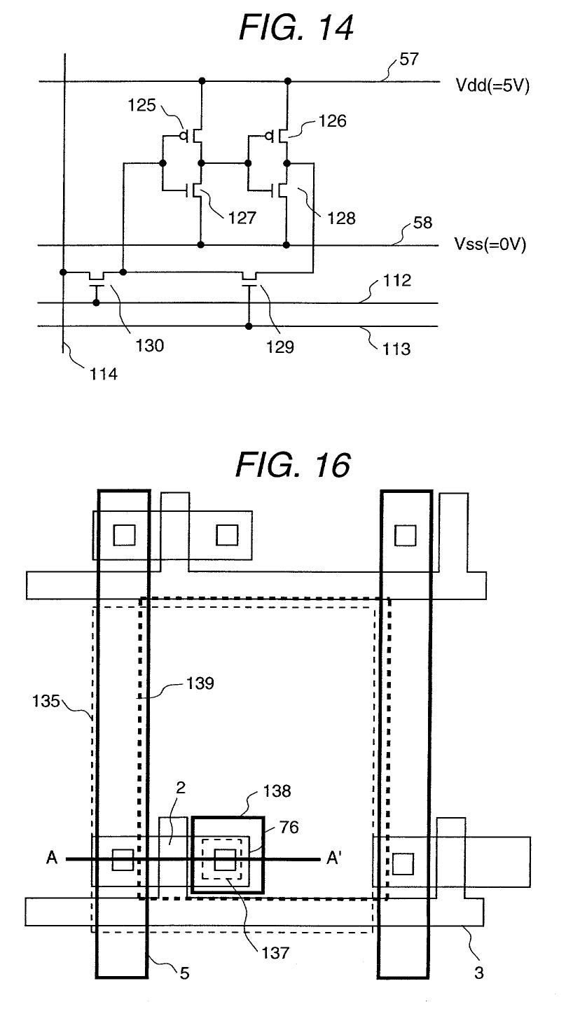

FIG. 14 shows the circuit structure of SRAM memory cell 111. The main body of the memory cell is a flip-flop composed of p-channel polysilicon TFT125,126 and n-channel polysilicon TFT127,128. Latch switch 129 controlled in latch line 113 has been inserted in the middle of the flip-flop circuit. This circuit is connected to data line 114 through word line switch 130 controlled by word line 112. The high voltage side of the flip-flop is driven by high voltage power wire 57 to which Vdd=5V is applied, and the low voltage side is driven by low voltage power wire 58 to which Vss=OV is applied.

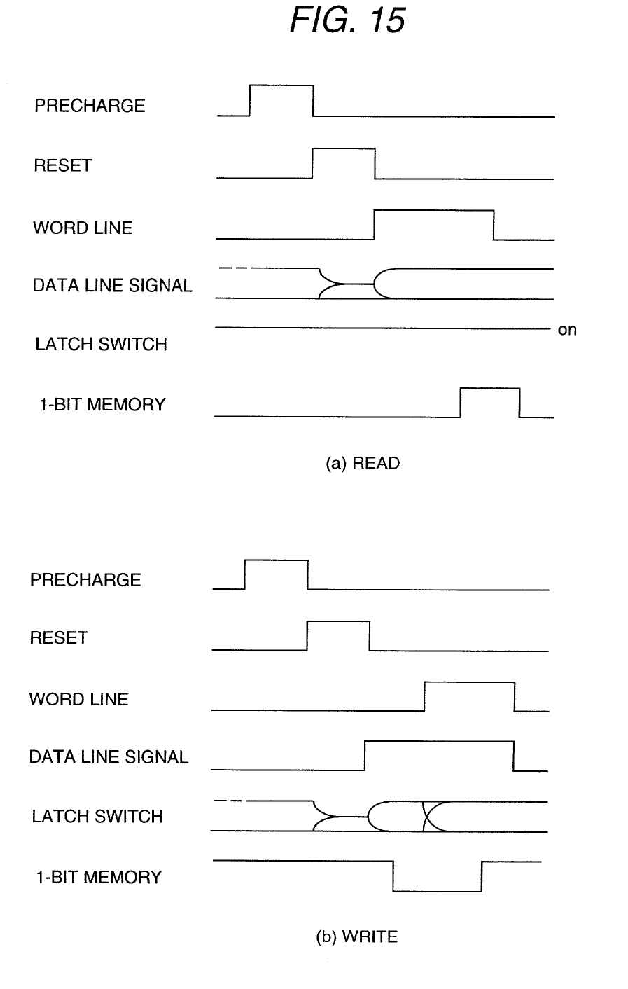

Next, the operation of the frame memory used in the low power consumption display mode in this embodiment is explained with reference to FIG. 15. FIG. 15(a) and (b) are the timing charts to which the reading operation of data from memory cell 111 and the writing operation of data to memory cell 111, respectively. The upper part shows the high voltage output ,that is, on-state, and the lower side shows the low voltage output, that is, off-state.

First of all, in reading, data line Vdd reset switch 118 and data line Vss reset switch 117 precharge data line 114 to high voltage (5V) and low voltage (0V), respectively. Then, it is reset, and data line short-circuit switch 116 is short-circuited between data lines 114 precharged to high voltage (5V) and low voltage (0V). Data line 114 is reset in the middle value of the low voltage level and the high voltage as shown in Figure. Next, when word line 112 selected by word line shift register 24 is turned on through line selection switch 121, buffer 119, and line drive switch 120, the data stored in the selected memory cell 111 is read to data line 114 as a signal voltage. Then, the data stored in memory cell 111 is read to one bit memory composed of data line latch a35, inverter 36, and data line latch b37 by turning on/turning off data line latch a35 and data line latch b36. At this time, latch switches 129 of all memory cells 111 always becomes an on-state through all latch lines 113 by buffer 119 and line drive switch 120.

The case where the content of the memory cell is read to bus 18, will be explained. At this time, it is similar to the case where data is read to one bit memory, excluding that word line 112 selected by Y decoder 23 is turned on through line selection switch 121, buffer 119, and line drive switch 120, and that the data of the address selected by X decoder 31, among the data read to data line 114, is output through data input switch 30, data input line 32, and data output buffer 34.

Next, also in writing, data line Vdd reset switch 118 and data line Vss reset switch 117 precharge data line 114 to high voltage (5V) and low voltage (0V), respectively. Then, it is reset, data lines 114 precharged to high voltage (5V) and low voltage (0V) are short-circuited by data line short-circuit switch 116. Therefore, data line 114 is reset to the middle value of the low voltage level and the high voltage level as shown in Figure. Next, When word line 112 selected by Y decoder 23 is turned on through line selection switch 121, buffer 119, and line drive switch 120, the data stored in the selected memory cell 111 is read to data line 114 as a signal voltage. These operation is similar to that of reading. In the writing operation, latch switch 129 of selected memory cell 111 is turned off when latch line 113 selected here with Y decoder 23 is turned off, and the flipflop function of memory cell 111 is stopped. When data input switch 30 selected by X decoder 31 is turned on, the input data input to data input line 32 from data input buffer 33 is input to the selected data line 114. As a result, the input data input to data line 114 is stored in memory cell 111 selected by Y decoder 23 and X decoder 31. At this time, it is clear that the data of memory cell 111 not selected by X decoder 31 never changes by the above-mentioned writing operation. Then, latch line 113 turns on latch switch 129, the flipflop of memory cell 111 begins to operate, and the selected word line 112 turns off. As a result, a series of writing operation is completed.

According to the present embodiment, it becomes possible always to carry out the stable writing operation even if there is the variation in an individual characteristic of polysilicon TFT which composes the flip-flop, because the flip-flop circuit is stopped at the time of writing operation to memory cell 111. As a result, the yield of frame memory 7 is improved.

(Third embodiment)

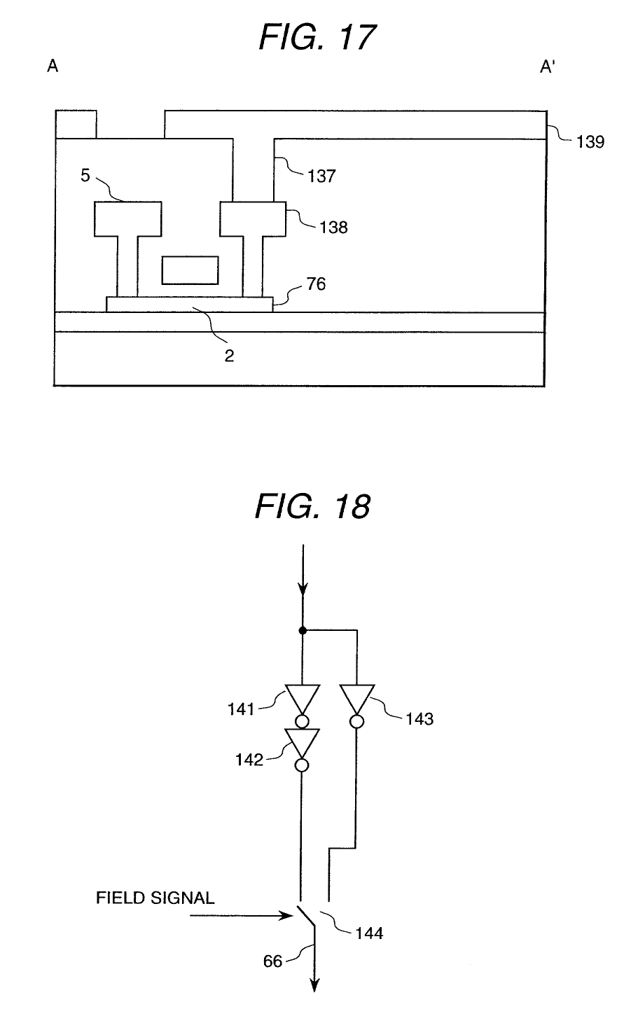

Hereinafter, a third embodiment according to the present invention will be explained with reference to FIGS. 16 and 17.

Because the main configuration and the operation of the polysilicon TFT liquid crystal display apparatus according to the third embodiment are the same as that of the first embodiment, the explanation is omitted. The difference between the first embodiment and this embodiment is in the configuration which uses a front light in place of back light 17 and the configuration of the display pixel. The configuration of the display pixel in this embodiment is explained hereinafter.

FIG. 16 is a schematic diagram of the layout of display pixel 135 in the third embodiment, and corresponds to FIG. 8 showing the first embodiment. The difference of this embodiment compared with the first embodiment is to have further provided reflecting electrode 139 on metal electrode 138 and contact hole 137 for connecting the reflecting electrode 139 and the metal electrode 138. In addition, FIG. 17 shows a sectional view taken along the line A-A′ in FIG. 16. The voltage of an analog image signal is applied to reflecting electrode 139 through contact hole 137. That is, reflecting electrode 139 acts as a reflecting plate to the front light, and an electrode which composes the capacity of the liquid crystal in the display pixel.

In this embodiment, there is an advantage that the numerical aperture when illuminating and reflecting can keep about 90% because the front light is used for the illumination to the liquid crystal display. Therefore, the brightness and the contrast of the panel when illuminating and reflecting can be improved.

(Fourth embodiment)

Hereafter, a fourth embodiment in the present invention is explained with reference to FIG. 18.

Because the main configuration and the operation of this embodiment are the same as that of the first embodiment, the explanation is omitted. The difference of this embodiment compared with the first embodiment is the configuration of low power consumption DA converter 6. This configuration is described.

FIG. 18 shows the circuit structure of the base unit in the polysilicon TFT liquid crystal display apparatus according to the fourth embodiment the fourth embodiment in the present invention, in which the base unit corresponds to one column of low power consumption DA converter 6. The data output from the frame memory 7 is input to inverter 141, 142, and inverter 143 every bit, and the output of both is connected to analog signal line 66 through field switch switch 144. Field switch switch 144 is controlled by the field signal.

This low power consumption DA converter 6 operates as a DA converter of the buffer or one bit. The data output from the frame memory 7 shows the display data by one bit. On the other hand, inverter 141,142 and inverter 143 perform the buffer processing from one bit to power supply voltages of 0V or 5V, and apply their output to analog signal line 66. In this embodiment, a common electrode of the liquid crystal is driven to the alternating current of 0/5V between fields. At this time, the output applied to analog signal line 66 must be reversed for instance in the same black like 5/0V between the fields. For that, field-switching switch 144 reverses the output voltage applied to analog signal line 66 between fields by selecting the output of inverter 141,142 or inverter 143.

In this embodiment, it is possible to decrease further the power consumption of the DA converter and the occupation area of frame memory 7 by having limited the analog image signal input to each display pixel at the low power consumption display mode to one bit (two gradation=eight colors).

(Fifth embodiment)

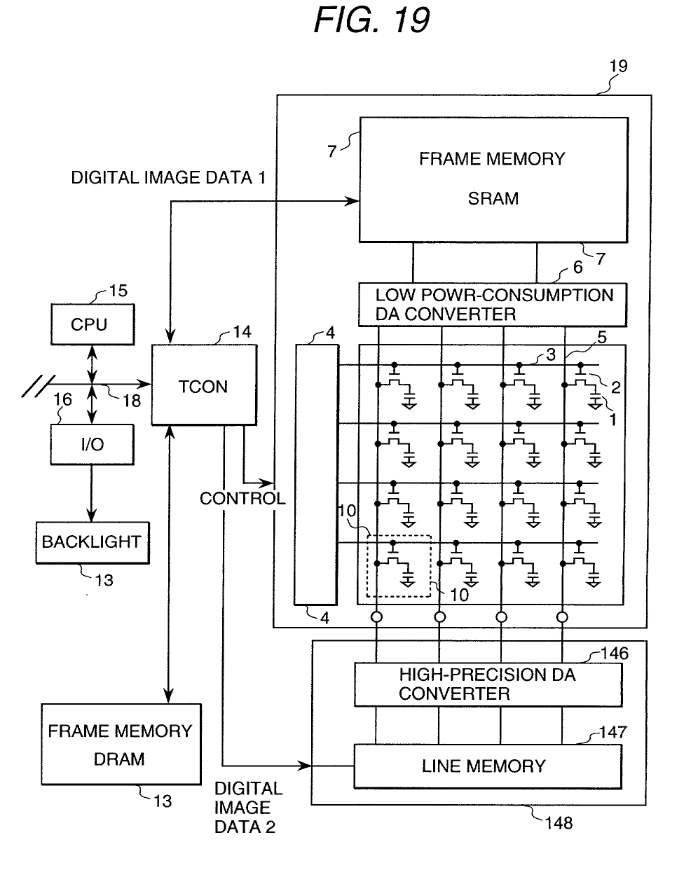

Hereafter, a fifth embodiment in the present invention is explained with reference to FIG. 19.

FIG. 19 shows the configuration of the polysilicon TFT liquid crystal display apparatus according to the fifth embodiment.

Because the main configuration and the operation of this embodiment are the same as that of the first embodiment, the explanation is omitted. The difference of this embodiment compared with the first embodiment is that highly accurate DA converter 146 and line memory 147 are composed on a single crystal Si substrate 148 as a LSI. The circuit structure and the operation of highly accurate DA converter 146 and line memory 147 are the same as the first embodiment.

In this embodiment, the area of driving circuit used in the high-definition display mode is reduced by forming highly accurate DA converter 146 and line memory 147 as a LSI on single crystal Si substrate 148, and mounting on a glass substrate 19.

Because the shrinkage to the heat process etc. in single crystal Si substrate 148 compared with glass substrate 19 is remarkably reduced, the suiting accuracy at the process can be excellent, and the area of the circuit made by a minute processing can be decreased.

It is also possible to appropriate the parts which are developed in general as a driver LSI for a-Si TFT, and mass-produced as they are as a LSI provided on the above-mentioned single crystal Si substrate 148. Moreover, it is also possible to use a highly accurate driver LSI which installs the DA converter of eight bits.

(Sixth embodiment)

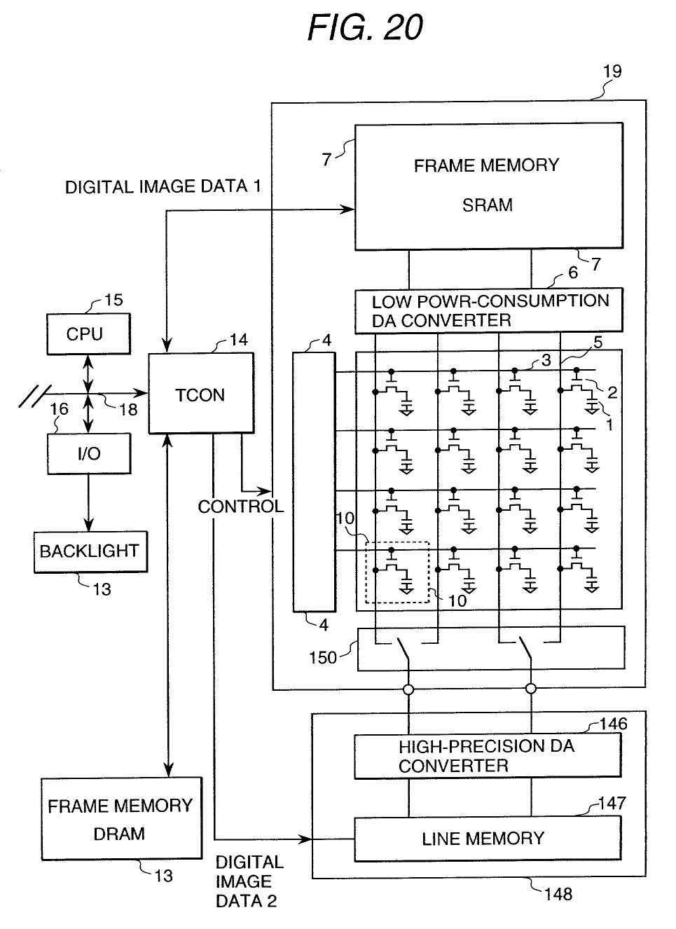

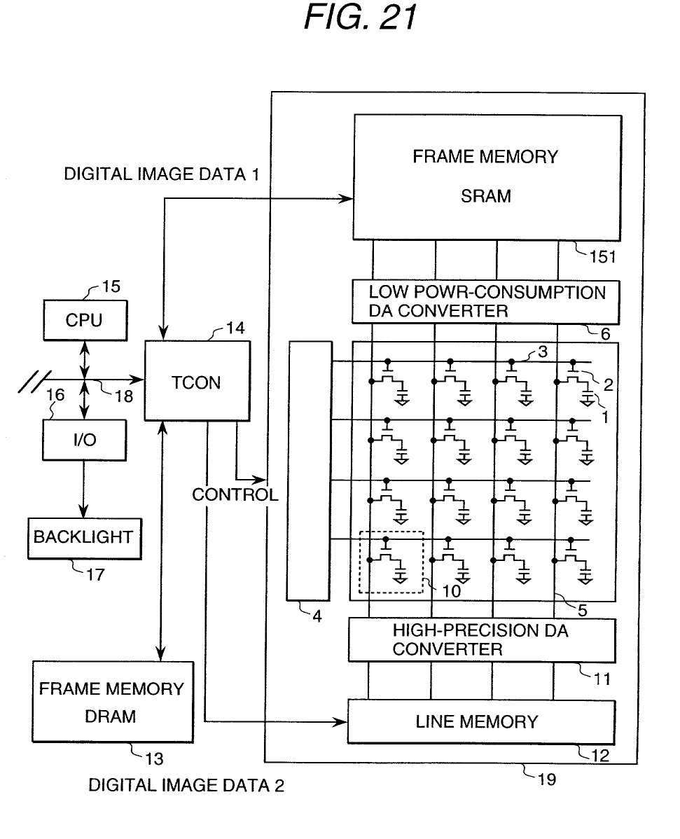

Hereafter, a sixth embodiment in the present invention is explained with reference to FIG. 20.

FIG. 20 shows the configuration of the polysilicon TFT liquid crystal display apparatus according to the sixth embodiment.

Because the main configuration and the operation of this embodiment are the same as that of the fifth embodiment, the detailed explanation is omitted. The difference of this embodiment compared with the fifth embodiment is to connect the output of highly accurate DA converter 146 provided in single crystal Si substrate 148 to signal line 5 through signal line selection switch 150 without connecting it directly to the signal line.

Signal line selection switch 150 is provided on glass substrate 19 by using the polysilicon TFT circuit, and has the role of distributing the analog image signal input from highly accurate DA converter 146 to plural signal lines 5 one by one in one horizontal display period.

In this embodiment, it is possible to decrease the number of wiring nodes to glass substrate 19 of single crystal Si substrate 148 by providing signal line selection switch 150.

Because signal line selection switch 150 has selected two signal lines in this embodiment, the number of above-mentioned wiring nodes is halves compared with that of the fifth embodiment.

it is clear that the number of above-mentioned wiring nodes becomes about 1/n of the number of the signal line if the number of signal lines selected by selection switch 150 is n (n is a natural number below the number of the signal line).

(Seventh embodiment)

Hereafter, a seventh embodiment in the present invention explained with reference to FIG. 21.

FIG. 21 shows the configuration of the polysilicon TFT liquid crystal display apparatus according to the seventh embodiment.

Because the main configuration and the operation of this embodiment are the same as that of the first embodiment, a detailed explanation is omitted. The structural difference of this embodiment compared with the first embodiment is to use frame memory 151 which uses a DRAM in place of frame memory 7 which uses a SRAM.

Although the operation of this embodiment is also basically similar to the first embodiment, the DRAM cell in frame memory 151 is refreshed at the same time when the display data of 60 display pixel per one second from frame memory 151 display is written.

The size of glass substrate 19 can be made smaller by simplifying the area of the cell of frame memory 151 by using the DRAM cell as a frame memory in this embodiment, and reducing the area of the frame memory.

It is also clear that the configuration in which frame memory 13 is a SRAM besides this can be adopted though frame memory 7 is especially assumed to be a DRAM configuration in this embodiment.

(Eighth embodiment)

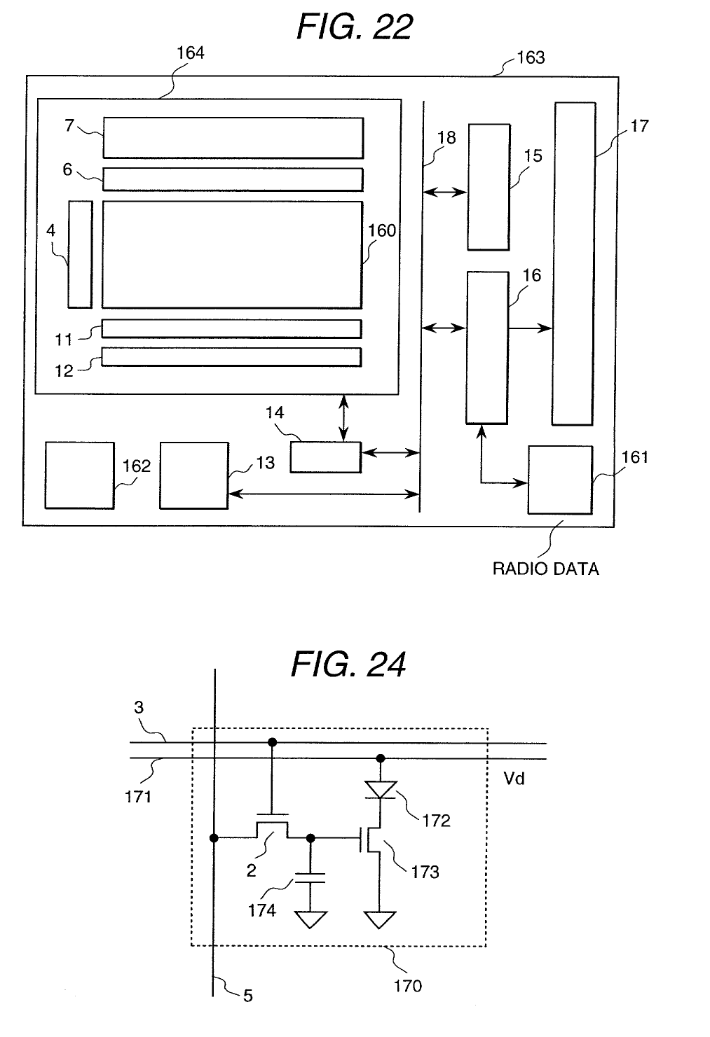

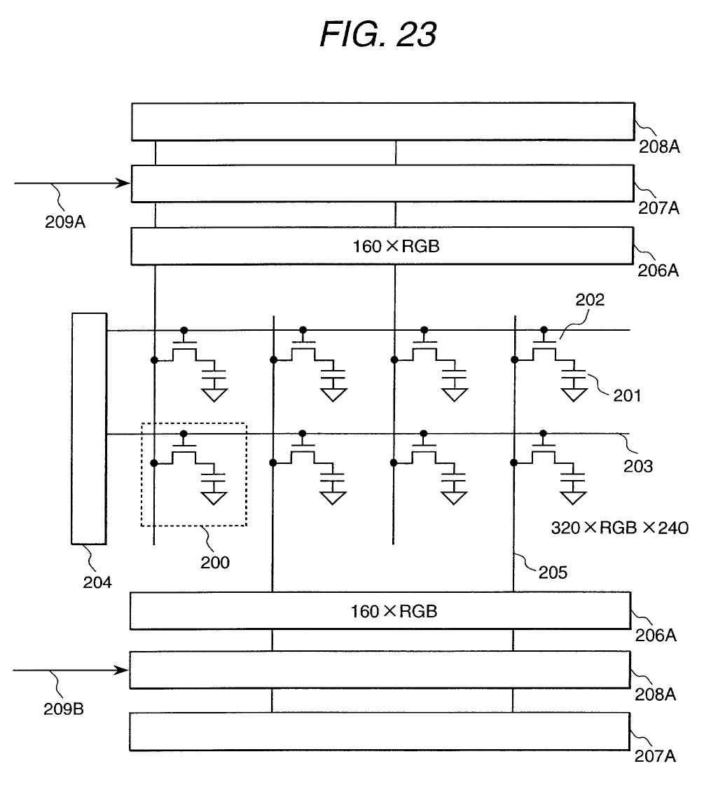

The eighth embodiment of the present invention is explained with reference to FIG. 22 hereafter.

FIG. 22 shows the configuration of image display terminal 163 according to the eighth embodiment.

The compressed image data inputs from the outside to wireless interface (I/F) circuit 161 as a radio data based on the bluetooth standard, and the output of wireless I/F circuit 161 is connected to bus 18 through I/O circuit 16. In addition, CPU15, TCON14, and frame memory 13, etc. are connected to bus 18. Further, the output of TCON14 is input to polysilicon TFT liquid crystal display apparatus 164, which has frame memory 7, low power consumption DA, converter 6, gate line shift register 4, display pixel matrix 160, highly accurate DA converter 11, and line memory 12. In addition, power supply 162 and back light 17 are provided in image display terminal 163. Back light 17 is controlled by I/O circuit 16. Because the internal configuration and the operation of polysilicon TFT liquid crystal display apparatus 164 is the same as the first embodiment, the detailed description is omitted.

The operation of the eighth embodiment is explained hereinafter. First, I/F circuit 161 fetches the compressed image data from the outside, and transmits this image data to CPU15 and frame memory 13 through I/O circuit 16. CPU15 receives the operation from the user, and drives image display terminal 163 or performing the decoding processing of the compressed image data if necessary. The image data decoded is temporarily accumulated in frame memory 13. When a high-definition display mode is selected, the image data is input from frame memory 13 to polysilicon TFT liquid crystal display panel 164 through TCON 14, and display pixel matrix 160 displays the input image in the frame memory one by one every one line according to the instruction of CPU 15. At this time, TCON14 outputs a fixed timing pulse necessary to display the image at the same time. It is described in the first embodiment that polysilicon TFT liquid crystal display apparatus 164 displays the image in display pixel array 160 by using these signals. At this time, I/O circuit 16 lights back light 17 if necessary. The secondary cell for supplying the electric power to the entire device is included in power supply 162 here.

Next, the power supply in the predetermined circuit parts such as frame memory 13, line memories 12, and highly accurate DA converters 11 is intercepted and the power consumption is reduced, after sending fixed image data from frame memory 13 to frame memory 7 through TCON 14 according to the instruction of CPU 15 when the low power consumption display mode is selected. It is described in the first embodiment that polysilicon TFT liquid crystal display panel 164 use the digital display data written in frame memory 7 at this time, and the displays the image in display pixel matrix 160. At this time, I/O circuit 16 turns off back light 17 as a rule. Moreover, the amount of the fixed data is reduced according to an instruction from CPU 15 when the image data is transfered from the frame memory 13 to frame memory 7 because the memory capacity of frame memory 7 is remarkably small compared with frame memory 13.

According to the eighth embodiment, it is possible to provide an image display terminal in which a high-quality image display and the low power consumption are obtained at the same time based on the compressed image data.

(Ninth embodiment)

The ninth embodiment in the present invention is explained with reference to FIG. 24.

FIG. 24 shows the pixel configuration of the image display unit according to the ninth embodiment.

Because the main configuration and the operation of this embodiment are the same as that of the first embodiment, the detailed explanation is omitted. The structural difference of this embodiment compared with the first embodiment is that electroluminescence effect (Hereafter, referred to as EL) display cell is used in place of the liquid crystal display cell as a configuration of pixel 170. Display pixel 170 has the pixel capacity 174 and pixel switch 2. The gate of pixel switch 2 is connected to gate line 3, and one end of pixel switch 2 is connected to signal line 5. These configuration is similar to that of pixel 10 in the first embodiment. However, in this embodiment, pixel switch 2 and the pixel capacity 174 are input to the gate of current drive TFT173 as it is and the drain side of current drive TFT173 is connected to fixed voltage line 171 where fixed voltage Vd was applied through EL diode 172.

The operation of the pixel part of this embodiment is explained. The analog signal voltage applied to signal line 5 is written in pixel capacity 174 through pixel switch 2 when gate line 3 is selected and turned on. In the same operation as that of the first embodiment, the analog signal voltage written is maintained in the pixel capacity 174 after pixel switch 2 becomes off-state again by gate line 3. However, the driving current corresponding to the value of the above-mentioned analog signal voltage flows to EL diode 172 in this embodiment because the above-mentioned analog signal voltage is input to the gate of current drive TFT 173. And because by this drive current, EL diode 172 emits light with the brightness which corresponds to the above-mentioned analog signal voltage, this embodiment can do the glow spontaneously display according to the analog signal voltage applied to signal line 5.

According to this embodiment, a high-quality image display and the low power consumption in the driving circuit of the signal line 5 are obtained at the same time as well as other embodiments.

It is needless to say that the liquid crystal layer and the back light described in the first embodiment are unnecessary because this embodiment is a glow spontaneously type display unit, and there is no necessity to drive the analog signal voltage input to the pixel at an AC because the liquid crystal is not possessed.

What is claimed is:

1. A image display apparatus having a display unit composed of a plurality of pixels and a control unit for controlling the display unit, further comprising:
a DA converter for converting the digital display data into an analog image signal,
wherein said DA converter is composed of a first DA converter and a second DA converter, the Power consumption when said first DA converter is operated being smaller than that when said second DA converter is operated,
wherein said DA converter operates either of said first DA converter and said second DA converter according to the instruction from said control unit, and outputs the converted analog image signal to said display unit, and
wherein said display unit changes the number of the independent display pixels of said display unit according to the instruction from said control, and displays according to said analog image signal.

2. A image display apparatus according to claim 1, wherein a gate line shift register for controlling the scanning of the display unit is connected to said display unit, said control unit outputs the instruction to said gate line shift register, and the number of independent display pixels of said display unit is changed by the gate line shift register, and a image is displayed.

3. A image display apparatus according to claim 2, wherein said control unit gives an instruction to said DA converter and the gate line shift register according to the mode switch instruction.

4. A image display apparatus according to claim 3, wherein said mode switch instruction has a first mode for carrying out the conversion processing by said first DA converter and a second mode for carrying out the conversion processing by said second DA converter, a pixel of said display unit is arranged corresponding to the region enclosed by plural gate lines and plural signal lines arranged to intersect with the plural gate lines, the gate line shift register controls at least two gate lines of said plural gate lines at the same timing in said first mode, and said first DA converter outputs one converted analog image signal to at least two signal lines.

5. A image display apparatus according to either one of claims 1 to 3, further comprising two memories each having different capacity,
wherein the two memories correspond to said first DA converter and said second DA converter, respectively.

6. A image display apparatus according to claim 5, wherein said display unit, said DA converter, said gate line shift register, and the memory having small capacity among said memories are arranged on the same substrate, and the memory with small capacity is formed by using polysilicon.

7. A image display apparatus according to claim 6, wherein said memory with small capacity corresponds to said first DA converter, and the memory with large capacity corresponds to said second DA converter.

8. A image display apparatus according to either one of claims 1 to 7, wherein said first DA converter and said second DA converter each convert the input signal into an analog image signal with different number of bit, respectively.

9. A image display apparatus according to either one of claims 1 to 7, wherein said first DA converter and said second DA converter each convert the input signal into an analog image signal with different maximum drive frequencyt, respectively.

10. A image display apparatus according to either one of claims 1 to 9, wherein said first DA converter outputs an analog image signal with binary gradation.

11. A image display apparatus according to either one of claims 1 to 10, further comprising an illumination means for supplying light to said display unit,
wherein the illumination means supplies light to said display unit in said second mode.

12. A image display apparatus comprising:
a display unit composed of plural pixels;
a control unit for controlling the display unit;
the image display apparatus further comprising a DA converter for converting digital display data into an analog image signal,
wherein said DA converter includes a first DA converter and a second DA converter, and
wherein said first DA converter and said second DA converter each convert the input signal into an analog image signal with different number of bit, respectively.

13. A image display apparatus according to claim 12, wherein either one of said first DA converter and said second DA converter converts digital data into an analog image signal in accordance with an instruction from said controller.

14. A image display apparatus according to claim 13, wherein said control unit gives an instruction to either one of said first DA converter and said second DA converter in accordance with the mode switch instruction.

15. A image display apparatus according to either one of claims 12 to 14, further comprising two memories each having different capacity,
wherein the two memories correspond to said first DA converter and said second DA converter, respectively.

16. A image display apparatus according to either one of claims 12 to 15, wherein said display unit, said DA converter and the gate line shift register are arranged on the same substrate, the shape of said display unit is rectangular, and the first DA converter and the second DA converter of said DA converters are arranged in the top and bottom of said display unit.

17. A image display apparatus according to claim 15, wherein the memory with small capacity of said two memories is arranged on the said substrate, and the memory with small capacity is formed with polysilicon.

18. A image display apparatus according to either one of claims 15 to 17, wherein said mode switch instruction has a first mode for carrying out the conversion processing by said first DA converter and a second mode for carrying out the conversion processing by said second DA converter, and wherein said memory with small capacity corresponds to said first DA converter, and the memory with large capacity corresponds to said second DA converter.

19. A image display apparatus according to either one of claims 13 to 18, wherein said display unit changes the number of the independent display pixels of said display unit according to the instruction from said control, and displays according to said analog image signal.

20. A image display apparatus according to either one of claims 12 to 19, wherein said first DA converter outputs an analog image signal with binary gradation.

21. A image display apparatus according to either one of claims 12 to 20, further comprising an illumination means for supplying light to said display unit,
wherein the illumination means supplies light to said display unit in said second mode.

22. A image display apparatus comprising:
a display unit composed of plural pixels;
a control unit for controlling the display unit;
the image display apparatus further comprising a DA converter for converting digital display data into an analog image signal,
wherein said DA converter includes a first DA converter and a second DA converter, and
wherein said first DA converter and said second DA converter each convert the input signal into an analog image signal with different frame frequency, respectively.

23. A image display apparatus according to claim 22, wherein either one of said first DA converter and said second DA converter converts digital data into an analog image signal in accordance with an instruction from said controller.

24. A image display apparatus according to claim 23, wherein said control unit gives an instruction to either one of said first DA converter and said second DA converter in accordance with the mode switch instruction.

25. A image display apparatus according to either one of claims 22 to 24, wherein said first DA converter outputs an analog image signal with binary gradation.

26. A image display apparatus according to either one of claims 22 to 25, further comprising an illumination means for supplying light to said display unit,
wherein the illumination means supplies light to said display unit in said second mode.
